(19) United States
(12) Patent Application Publication
(10) Pub. No.: US 2022/0093319 A1
(43) Pub. Date: Mar. 24, 2022

(54) MAGNETIC MODULE AND ELECTRICAL CONNECTOR INCLUDING THE MAGNETIC MODULE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventor: YONG-CHUN XU, Kunshan (CN)

(21) Appl. No.: 17/476,366

(22) Filed: Sep. 15, 2021

(30) Foreign Application Priority Data
Sep. 18, 2020 (CN) 202010983495.X

(51) Int. Cl. H01F 27/28; H01F 27/24; H01F 19/04; H01R 13/719; H01R 24/64

(52) U.S. Cl. CPC H01F 27/2823; H01F 27/24; H01R 24/64; H01F 19/04; H01R 13/719; H01F 27/2895

(57) ABSTRACT

A magnetic module includes: a magnetic core; a primary coil wound on the magnetic core, the primary coil includes a first group of enameled wires and a second group of enameled wires; a secondary coil wound on the magnetic core, the secondary coil includes a third group of enameled wires and a fourth group of enameled wires, wherein the number of enameled wires of the third group of enameled wires is the same as that of the fourth group of enameled wires, the number of enameled wires of the first group is the same as that of the second group of enameled wires, and the number of the first group of enameled wires and the second group of enameled wires is greater than the number of the third group of enameled wires and the fourth group of enameled wires.

### BACKGROUND OF THE INVENTION

### 1. Field of the Invention

The present invention relates generally to a magnetic module and an electrical connector including the magnetic module, and more particularly to a magnetic module and an electrical connector including the magnetic module suitable for an Ethernet circuit.

### 2. Description of Related Arts

Power over Ethernet (PoE) is a technology that can transmit power and data to devices in Ethernet. Ethernet to transmit DC power on the data transmission line at the same time, so that small data devices can be directly powered by the Ethernet connection, and electronic devices that are powered by Ethernet can be used without additional power outlets, Electronic equipment powered by Ethernet can be used without additional power outlets, so it can save time and money to configure power outlets, the cost of the entire equipment system is relatively reduced. In the PoE system, the device that provides power is called Power Sourcing Equipment or PSE, and the equipment that uses power is called Powered Device (PD). Through this technology, devices including Internet phones, wireless base stations, cameras, hubs, and microwave devices can be powered by PoE technology.

China Patent No. 205751811 discloses a magnetic module including a magnetic core, a primary coil and a secondary coil wound on the magnetic core, a first center tap on the primary coil side and a second center tap on the secondary coil side. Each of the primary coil and the secondary coil is composed of one enameled wire. In the Power over Ethernet (PoE) system, the heat mainly comes from the power and signal mixing area. According to the formula R=ρ*L/S and W=P=I*I*R. If the diameter of the enameled wire is smaller, the resistance will be larger. When the current passes through the wire, the temperature rise is likely to be too high, resulting in a large power loss, which cannot meet the demand for high-power supply. In order to reduce resistance and power consumption, the cross section S of the enameled wire must be large enough, but a single large diameter enameled wire has a high tension during the winding and bending process, which will easily cause the outer layer of the paint to rupture. However, if the primary coil and the secondary coil increase the number of enameled wires at the same time to increase the cross-sectional area, when the multiple wires are twisted together, it is easy to cause the problem that the wires are too hard and not easy to twist.

An improved magnetic module and an electrical connector including the magnetic module is desired.

### SUMMARY OF THE INVENTION

A main object of the present invention is to provide a magnetic module that supports filtering and power supply, has low power loss, and is easy to wind.

To achieve the above-mentioned object, a magnetic module comprises: a magnetic core; a primary coil wound on the magnetic core, the primary coil includes a first group of enameled wires and a second group of enameled wires, the first group of enameled wires and the second group of enameled wires forming a primary input end, a primary output end, and a first center tap; a secondary coil wound on the magnetic core, the secondary coil includes a third group of enameled wires and a fourth group of enameled wires, wherein the number of enameled wires of the third group of enameled wires is the same as that of the fourth group of enameled wires, the number of enameled wires of the first group is the same as that of the second group of enameled wires, and the number of the first group of enameled wires and the second group of enameled wires is greater than the number of the third group of enameled wires and the fourth group of enameled wires.

To achieve the above-mentioned object, an electrical connector includes a magnetic module including: a magnetic core; a primary coil wound on the magnetic core, the primary coil includes a first group of enameled wires and a second group of enameled wires, the first group of enameled wires and the second group of enameled wires forming a primary input end, a primary output end, and a first center tap; a secondary coil wound on the magnetic core, the secondary coil includes a third group of enameled wires and a fourth group of enameled wires, wherein the number of enameled wires of the third group of enameled wires is the same as that of the fourth group of enameled wires, the number of enameled wires of the first group is the same as that of the second group of enameled wires, and the number of the first group of enameled wires and the second group of enameled wires is greater than the number of the third group of enameled wires and the fourth group of enameled wires.

Compared to the prior art, the primary coil for transmitting power and signal uses multiple stranded wires to achieve a larger cross-sectional area, thereby reducing the resistance and heating power of the coil, the number of enameled wires in the secondary coil for signal transmission is less than that of the primary coil, so that the magnetic module can filter and supply power, and it is also convenient for winding the enameled wire.

### BRIEF DESCRIPTION OF THE DRAWING

FIG. 1 is a schematic diagram of magnetic module in accordance with the present invention and common mode choke coil connected with it;

FIG. 2 is a circuit schematic of magnetic module and the common mode choke coil connected to it in FIG. 1;

FIG. 3 is a schematic diagram of the wire ends spreading out after the magnetic module is wound in FIG. 1;

FIG. 4 is a perspective view of an electrical connector including the magnetic module in FIG. 3; and

FIG. 5 is the circuit diagram of electrical connector in FIG. 4.

### DETAILED DESCRIPTION OF THE PREFERRED EMBODIMENT

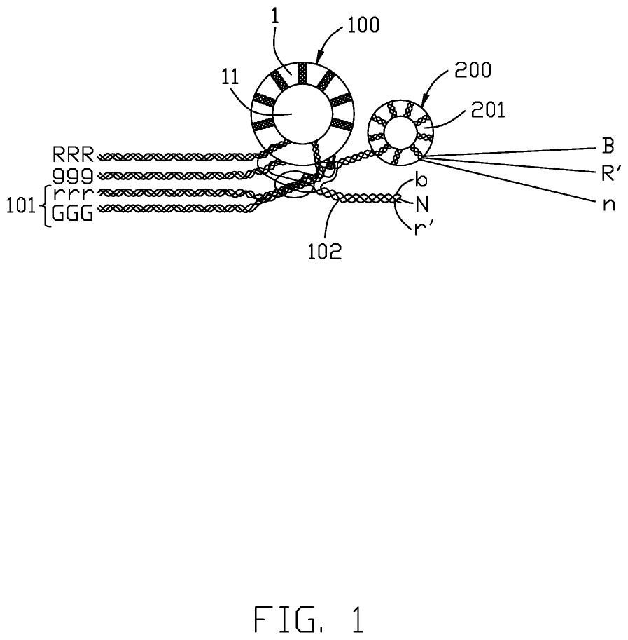

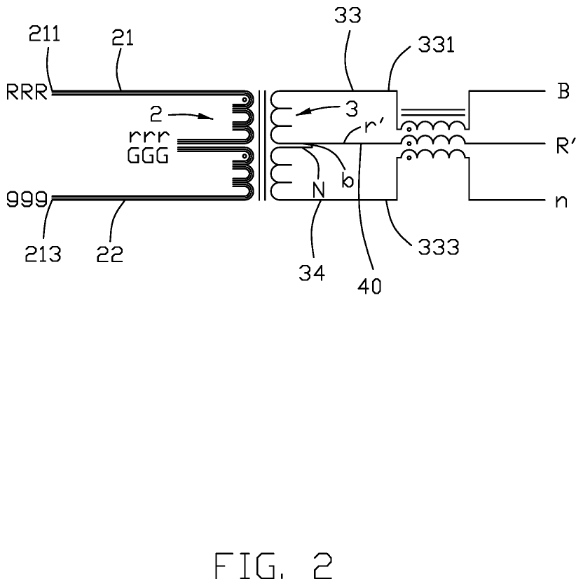

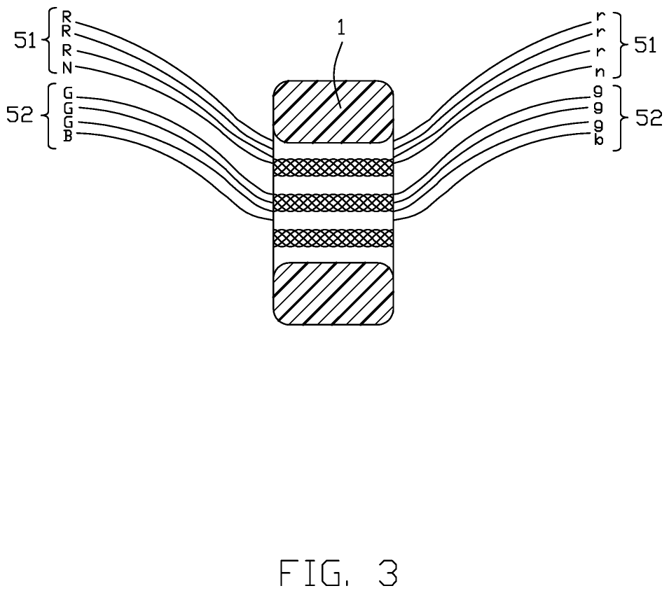

Referring to FIGS. 1-5, a magnetic module 100 in accordance with the present invention is shown. It can support 2.5 Gbps filter circuit and 200 watt power supply circuit. The magnetic module 100 is actually a transformer. The magnetic module 100 includes a toroid or magnetic core 1 and a primary coil 2 and a secondary coil 3 wound on the magnetic core 1. The magnetic core 1 has a central through hole 11. The primary coil 2 includes a first group of enameled wires 21 and a second group of enameled wires 22. The secondary coil 3 includes a third group of enameled wires 33 and a fourth group of enameled wires 34. The third group of enameled wires 33 and the fourth group of enameled wires 34 have the same number. The number of the first group of enameled wires 21 and the second group of enameled wires 22 are the same. The number of the first group of enameled wires 21 and the second group of enameled wires 22 is greater than the number of the third group of enameled wires 33 and the fourth group of enameled wires 34. Preferably, each of the first group of enameled wires 21 and the second group of enameled wires 22 include three enameled wires in the present invention. Each of the third group of enameled wires 33 and the fourth group of enameled wires 34 include one enameled wire, and the diameter of the two enameled wires is the same. The diameter size is between 0.064 mm and 0.127 mm. The diameters of the three enameled wires in the first group of enameled wires 21 are the same. The diameters of the three enameled wires in the second group of enameled wires 22 are the same. And the diameter of each enameled wire of the first group of enameled wires 21 is the same as the diameter of each enameled wire of the second group of enameled wires 22. The diameter of each enameled wire of the first group of enameled wires 21 and the second group of enameled wires 22 is between 0.102 mm and 0.203 mm. The parts of the first group of enameled wires 21 and the fourth group of enameled wires 34 wound around the magnetic core 1 are twisted together to form a first stranded wire 51. The portions of the second group of enameled wires 22 and the third group of enameled wires 33 wound around the magnetic core 1 are twisted together to form a second stranded wire 52. The first twisted wire 51 and the second twisted wire 52 are twisted together into a bundle, and are wound around the magnetic core 1 in a manner that penetrates the central through hole 11, and expose the end of each group of enameled wire.

Each enameled wire has a first thread and a second thread. The first group of enameled wire 21 is red. Each enameled wire in the first group of enameled wires 21 comprises a first thread R and a second thread r. The second group of enameled wire 22 is green. Each enameled wire in the second group of enameled wires 22 comprises a first thread G and a second thread g. The third group of enameled wire 33 is blue. Each enameled wire in the third group of enameled wires 33 comprises a first thread B and a second thread b. The fourth group of enameled wire 34 is natural. Each enameled wire in the fourth group of enameled wires 34 comprises a first thread N and a second thread n. The color of the enameled wire is just for easy distinction, and other colors can also be used instead.

The first thread RRR of the three enameled wires of the first group of enameled wires 21 collectively serve as the primary input end 211 of the primary coil 2 of the transformer. The second thread rrr of the first group of enameled wires 21 and the first thread GGG of the second group of enameled wires 22 together form a first center tap 101. The second thread ggg of the three enameled wires of the second group of enameled wires 22 are collectively used as the primary output end 213 of the transformer primary coil 2. The first thread B of an enameled wire of the third group of enameled wires 33 is used as the secondary input end 331 of the transformer secondary coil 3. The second thread b of the third group of enameled wires 33 and the first thread N of the fourth group of enameled wires 34 together form a second center tap 102. The second thread n of the fourth group of enameled wire 34 is the secondary output end 333 of the transformer secondary coil 3. The first center tap 101 is twisted into one bundle, and the second center tap 102 is twisted into another bundle. The first center tap 101 extends to be electrically connected to external components. The tail end of the second center tap 102 is immersed in tin and short-circuited and then suspended.

The filter module also includes a common mode choke 200. Common mode choke coil 200 includes common mode core 201. Add a red enameled wire 40, which includes the first thread R′ and the second thread r′. Twist the red wire 40 with bN and Bn and wind it around the common mode core 201 to form windings bNr′ and BnR′.

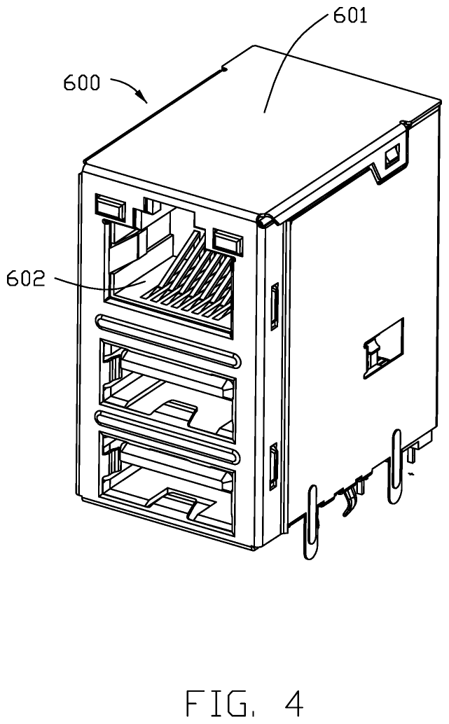

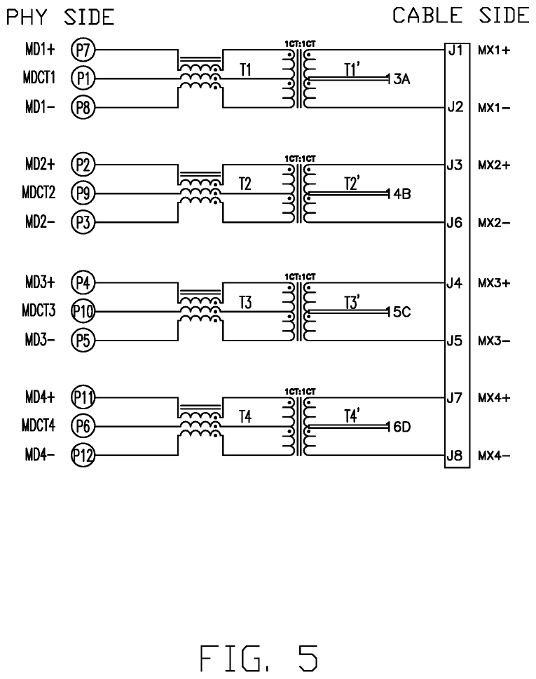

Referring to FIG. 4, an electrical connector 600 in accordance with the present invention includes a housing 601, an insulating body 602 housed in the housing 601, and a magnetic module 100 housed in the housing 601. Referring to FIGS. 5, a circuit diagram of the electrical connector according to the present invention. It includes four channels, and each channel includes a magnetic module of the present invention. 13A, 14B, 15C, and 16D are respectively equivalent to the first center tap 101 of the magnetic module of the present invention

In the Power over Ethernet (PoE) system, the heat mainly comes from the power and signal mixing area. According to the formula R=ρ*L/S and W=P=I*I*R, if the diameter of the enameled wire is smaller, the resistance will be larger. When the current passes through the wire, the temperature rise is likely to be too high, resulting in a large power loss, which cannot meet the demand for high-power supply. In order to reduce resistance and power consumption, the cross section S of the enameled wire must be large enough, but a single large diameter enameled wire has a high tension during the winding and bending process, which will easily cause the outer layer of the paint to rupture. However, if the primary coil and the secondary coil increase the number of enameled wires at the same time to increase the cross-sectional area, when the multiple wires are twisted together, it is easy to cause the problem that the wires are too hard and not easy to twist.

In the present invention, the primary coil for transmitting power and signal use multiple enameled wires to achieve a larger cross-sectional area to reduce the resistance and heating power of the coil. However, the number of enameled wires in the secondary coil for pure signal transmission is less than that in the primary coil area, in order to reduce the resistance and heating power of the coil while taking into account the filtering and supporting the power, and the magnetic module of the present invention is easy to wind.

What is claimed is:

1. A magnetic module comprising:
a magnetic core;
a primary coil wound on the magnetic core, the primary coil includes a first group of enameled wires and a second group of enameled wires, the first group of enameled wires and the second group of enameled wires forming a primary input end, a primary output end, and a first center tap;
a secondary coil wound on the magnetic core, the secondary coil includes a third group of enameled wires and a fourth group of enameled wires, wherein
the number of enameled wires of the third group of enameled wires is the same as that of the fourth group of enameled wires, the number of enameled wires of the first group is the same as that of the second group of enameled wires, and the number of the first group of enameled wires and the second group of enameled wires is greater than the number of the third group of enameled wires and the fourth group of enameled wires.

2. The magnetic module as claimed in claim 1, wherein the magnetic module supports a 2.5 Gbps filter circuit and a 200 watt power supply circuit.

3. The magnetic module as claimed in claim 1, wherein each of the first group of enameled wires and the second group of enameled wires has three enameled wires, and each of the third group of enameled wires and the fourth group of enameled wires has only one enameled wire.

4. The magnetic module as claimed in claim 3, wherein the diameter of each of the first group of enameled wires is equal to the diameter of each of the second group of enameled wires.

5. The magnetic module as claimed in claim 4, wherein the diameter of each enameled wire of the first group of enameled wires and the second group of enameled wires is between 0.102 mm and 0.203 mm, and the diameter of each enameled wire of the third group of enameled wires and the fourth group of enameled wires is between 0.064 mm and 0.127 mm

6. The magnetic module as claimed in claim 5, wherein respective parts of the first group of enameled wires and the forth group of enameled wires wound around the magnetic core are twisted together, and respective parts of the second group of enameled wires and the third group of enameled wires wound around the magnetic core are twisted together.

7. The magnetic module as claimed in claim 6, wherein the first group of enameled wires and the second group of enameled wires after twisting and the third group of enameled wires and the fourth group of enameled wires after twisting are again twisted into a bunch and wound on the magnetic core.

8. The magnetic module as claimed in claim 5, wherein the third group of enameled wires and the fourth group of enameled wires form a second center tap, and a tail end of the second center tap is connected by immersion in tin.
